(19) United States
(12) Patent Application Publication
(10) Pub. No.: US 2017/0004160 A1
(43) Pub. Date: Jan. 5, 2017

(54) Method and System for Feature-Selectivity Investigative Navigation

(71) Applicants: Carcema Inc., Gatineau (CA); 6899005 Canada Inc., Gatineau (CA)

(72) Inventor: Joshua Turner, Gatineau (CA)

(21) Appl. No.: 15/196,902

(22) Filed: Jun. 29, 2016

Related U.S. Application Data
(60) Provisional application No. 62/188,235, filed on Jul. 2, 2015.

(51) Int. Cl. G06F 17/30

(52) U.S. Cl. CPC G06F 17/30321; G06F 17/3043

(57) ABSTRACT

The present invention provides methods and systems for feature-selectivity investigative navigation of a plurality of resources, comprising the steps of extracting at least one feature, the at least one feature corresponding to at least one resource, the at least one feature represented as a key value pair including a key corresponding to the nature of the at least one feature and a value corresponding to the semantic value of the at least one feature, indexing the at least one feature in a data store and displaying the relationship between the at least one feature and the plurality of resources.

### FIELD

The present invention relates to information management and governance. More specifically, the present invention relates to methods and systems for navigating graphs of documents and features adapted to discover connections between a plurality of documents stored in a database.

### BACKGROUND

In the fields of information management and governance, it is often necessary during investigations to discover connections between the documents in an unstructured collection which are not explicitly stated, but are nonetheless present and can be determined from word patterns present in two or more documents under consideration.

As will be readily appreciated by the skilled person, some of these connections can lie in completely isolated references to people, places, or things that appear a handful of times through the collection or resources. In other cases, the presence of a specific run of words or unique turns of phrase can create the seed for a line of investigation into the similarity of two or more documents.

Some of the most interesting and useful connections that can be gleaned from two or more documents or digital resources are the connections that are drawn from the most complex patterns that turn up the least frequently. From a human perspective, discovering these links is done intuitively; a name or place can “ring a bell” in an investigator's memory. On the other hand, programmed algorithms have no such intuition. As will be readily appreciated by the skilled person, computers are very good at finding the most common connections, but are relatively poor at finding connections that can often yield useful investigative outcomes.

Accordingly, there is a need for systems and methods for autonomously identifying infrequent and complex patterns in at least two documents under consideration.

### BRIEF SUMMARY

It is contemplated that the present invention provides methods and systems for feature-selectivity investigative navigation of a plurality of resources, having the steps of extracting at least one feature from each of the plurality of resources, the at least one feature corresponding to each of the plurality of resources, the at least one feature represented as a key value pair including a key corresponding to the nature of the at least one feature and a value corresponding to the semantic value of the at least one feature, indexing the at least one feature in a data store, and displaying the relationship between each at least one feature and the plurality of resources.

### BRIEF DESCRIPTION OF THE FIGURES

The present invention will be better understood in connection with the following figures, in which:

FIG. 1 is an illustration of at least one embodiment of a computer terminal for use in connection with the present invention;

FIG. 2 is an illustration of at least one embodiment of at least two computer terminals as illustrated in FIG. 1 in electronic communication over a network; and

FIG. 3 is an illustration of at least one embodiment of a system and method in accordance with the present invention; and

FIG. 4 is an illustration of another embodiment of a system and method in accordance with the present invention.

### DETAILED DESCRIPTION OF THE EMBODIMENTS

It is contemplated that in at least one embodiment the present invention can provide a Feature-Selectivity Investigative Navigator (“FSIN”) that can help alleviate the inherent subjectivity involved with determining “interesting” connections between documents when using fundamentally resource intensive and error-prone methods of human-checking document similarity on a case by case basis. It is contemplated that this can be achieved by first breaking documents down into sets of features, then modelling interest as a function of rarity and interest factor of particular document or digital resource's features being considered.

In the present context, it will be appreciated that a document is one type of digital resource that can also be understood to include text files and documents, image files and documents, music files, among any other type of digital files that will be readily appreciated by the skilled person.

It is contemplated that the presently considered features can include, but are not limited to, metainformation values, terms, sequences of terms, n-grams of terms, named entities, or any other machine-identifiable property that can be calculated within the context of a single document or digital resource, as will be readily understood by the skilled person.

In at least one embodiment, it is contemplated that features can be assigned an “interest factor” based on their nature and characteristics. Moreover, it is contemplated that complete identifiers, such as but not limited to, email addresses, can be assigned a higher interest factor than short words, for example.

In at least one embodiment, it is contemplated that the rarity, r, of a connection can be defined as:

$$r = \frac{1}{i - 1}$$

Where i is the incidence of the feature in the collection and can extend from 1 to ∞, however other suitable methods of determining rarity will be readily appreciated by the skilled person.

It is further contemplated that candidate connections can also be culled by semantic similarity. In these embodiments, it is contemplated that only documents or digital resources which have substantially different content are considered candidate pairs.

Example: Feature-Selectivity Investigative Navigator (FSIN)

Step 1: Assemble Feature Set

In at least one embodiment, for each resource under consideration, a set of features is extracted. In these embodiments it is contemplated that features are key-value pairs, with the (non-unique) key describing the nature of the feature, and the value holding a token representing the semantic value of the feature. It is further contemplated that resources having shared pairs of features have the same semantic attributes.

As discussed above, it is contemplated that features can come from several sources, including, but not limited to:

Single-value features: It is contemplated that certain features can have only one key-value pair per resource; examples include but are not limited to the length of the byte stream, the cryptographic digest of the resource and a file system owner attribute, among other single-value features that will be readily appreciated by the skilled person.

Multiple-value features: It is further contemplated that other features can have more than one value per resource; examples include, but are not limited to words in the text stream and named authors, among other multiple-value features that will be readily appreciated by the skilled person.

Calculated value features: It is further contemplated that another class of features can be derived from processes that parse the resource. For example:

Phrase n-grams features: In the presently disclosed methods and systems, it is contemplated that one useful set of calculated value features is a set of n-grams calculated from a stream of text. A rolling window of a fixed size per feature key can be used to separate text into n-lets (doublets, triplets, quadruplets) dependent on the window size:

In this example, a window of size 3 applied to the input text “I really like walking in the rain” would produce:
I really like (i.e.: the first three words)
really like walking (i.e.: the subsequent three words)
like walking in (i.e.: the subsequent three words)
walking in the (i.e.: the subsequent three words)
in the rain (i.e.: the final three words)

This set of n-lets (and more specifically in this case, triplets) can then be lemmatized, or in other words, reduced to root word-forms, flattened to lowercase, and the elements within the set sorted alphabetically to become n-grams as will be readily understood by the skilled person. The example set out above becomes:

TABLE 1
n-let to n-gram Conversions

| n-let (n = 3) | n-gram (n = 3, lemmatized) |
|---|---|
| I really like: | i like real |
| really like walking | like real walk |
| like walking in | in like walk |
| walking in the | in the walk |
| in the rain | in rain the |

The resultant lemmatized n-grams can then subsequently be passed through a uniform hash function that produces a multibyte token (which can be considered a hash output or a digest) that represents each n-gram more densely than the text of the n-gram itself. For example:

TABLE 2
n-let to n-gram to Hashed Token Conversions

| n-let (n = 3) | n-gram (n = 3) | Hashed Token |
|---|---|---|
| I really like: | i like real | fg/H4r |
| really like walking | like real walk | r4EGH1 |
| like walking in | in like walk | /284Fb |
| walking in the | in the walk | 2SnHr/ |
| in the rain | in rain the | 83Edul |

Finally, it is contemplated that the resultant set of tokens are placed in the set of features assigned to the resource:
Set (features) : fg/H4r r4EGH1/284Fb 2SnHr/83Edul

Other calculated features: It is contemplated that depending on the nature of the underlying resource, other types of features could conceivably be extracted, such as but not limited to, beats-per-minute, duration, or center-crossing values for audio applications; facial recognition or other visual feature extractions for image-based applications; barcode/patchcode recognition in certain image-based applications, among other arrangements that will be readily appreciated by the skilled person.

Step 2: Indexing

It is next contemplated that the set of features can then subsequently be committed to a “concordance of features” data store. In at least one embodiment it is contemplated that the key characteristic of such a store is the ability to efficiently retrieve a list of resources all possessing a given feature. In at least one embodiment, a record level inverted index is a typical data structure that could be used in this role, among other arrangements that will be readily appreciated by the skilled person.

Step 3: Feature Exploration

Next, it is contemplated that the process of exploring the graph of features can be undertaken by presenting the user with an interface that presents a network of resources and features. In some embodiments, it is contemplated that the user begins their exploration by choosing a “pivot” resource or feature as a starting point, and the exploration proceeds depending on the nature of the starting point as follows:

Step 3(a): Pivot on Resource

In some embodiments, it is contemplated that the set of features possessed by the given resource can be either retrieved or recalculated, and the features can then subsequently be sorted according to a set of “quality factors” which will vary from implementation to implementation.

In some embodiments, it is contemplated that features which identify people, places, and things are assigned high quality factors. Next, it is contemplated that features with longer values can be highly ranked, and so on. It is further contemplated that this set of sorted features becomes the resource's “concordance”.

In some embodiments, it is contemplated that the set of elements in the concordance can be traversed in descending order. It is contemplated that as each feature is traversed, an underlying data store can subsequently retrieve the set of resource identifiers of resources that possess the given feature under consideration. The retrieved set for each feature is called the corresponding “feature vector”. With reference to the n-gram example cited above, and assuming that the present method is pivoting on resource “4” can result in the following set:

TABLE 3
Retrieval of Feature Vector and Identifying Pivot Resource

| Feature | Resultant Feature Vector |
|---|---|
| (represented | (i.e: Set of Retrieved |
| as Hashed | Identifiers for Resources |
| Token) | where Feature is Concordant) |
| fg/H4r | Resource Nos: 1, 4, 5, 34, |
| | 56, 12, 3, 15, 7, 78 |
| r4EGH1 | Resource Nos: 4, 6 |
| /284Fb | Resource Nos: 6, 2, 4, 56, |
| | 23, 104, 45, 34, 5 |
| 2SnHr/ | Resource Nos: 1, 4, 56, 34, 2 |
| 83Edul | Resource No: 4 |

In some embodiments, it is contemplated that each feature vector can then subsequently be traversed, counting the number of identifiers which represent resources which are neither the pivot resource, nor represent resources which are substantially similar to the pivot document.

As will be understood by the skilled person, considering resources that are deemed substantially similar to the pivot resource will result in unnecessary computational allocation and also will overrepresent the prevalence of the considered feature, thereby over stating the true commonness of that feature in the entire set of resources under consideration. In other words, it is contemplated that comparing substantially similar resources to one another provides little insight into the true incidence (and relative commonality or rarity) of the considered feature across the set of resources under consideration.

It is contemplated that traversal continues until either the set of collected resources exceeds a threshold for “commonness” or the vector is exhausted, as discussed in further detail below.

Step 3(a)(1): Identification of Similarity

With reference to the example provided above, if resources 1 and 56 are designated “substantially similar” to the pivot resource (i.e: resource 4) for illustrative purposes, and further that three instances is the predetermined threshold for “commonness” between documents. It is contemplated that similarity can be determined by a number of known and/or proprietary methods as will be readily understood by the skilled person and depending on the resultant application of the present invention.

For the purposes of this example, the comparison outcomes are as follows: (Note: Discarded resources are flagged with an asterisk)

TABLE 4
Identification of Similarity of Resources based
on Retrieved Feature and Pivot Document

| Feature | Resultant Feature Vector | |
|---|---|---|
| (represented | (i.e: Set of Retrieved | |
| as Hashed | Identifiers for Resources | |
| Token) | where Feature is Concordant) | Analysis |
| fg/H4r | Resource Nos: 1*, 4*, 5, 34, | Too common. Note that |
| | 56*, 12, 3, 15, 7, 78 | 3, 15, 7, 78 are not even |
| | | considered, since the |
| | | term is already too |
| | | common (>3) once |
| | | resources 5, 34 and 12 |
| | | are considered. |
| r4EGH1 | Resource Nos: 4*, 6 | Interesting. Term |
| | | appears in only one |
| | | other resource, 6. |
| /284Fb | Resource Nos: 6, 2, 4*, 56*, | Too common. As above, |
| | 23, 104, 45, 34, 5 | once we reach 23, we |
| | | know that this term can |
| | | safely be dropped as it |
| | | is already too common |
| | | (>3) once 6, 2 and 23 are |
| | | considered |
| 2SnHr/ | Resource Nos: 1*, 4*, 56*, | Interesting. Term |
| | 34, 2 | appears in only two |
| | | other resources, 42 and |
| | | 2. |
| 83Edul | Resource No: 4* | Not interesting. Term is |
| | | unique in the collection |
| | | to pivot resource. |

Note:
1, 4 and 56 are not considered in any of the above comparisons as these resources are predetermined as the pivot (4) or substantially similar to pivot (1, 56)

Where necessary, the set of human-readable values for the linking features (in this case, n-gram tokens) are retrieved, and the final result presented as a non-directed graph:

Resource 4:
“really like walking” also appears in resource 6
“walking in the” also appears in resources 34 and 2

The user is then presented with the option of navigating to either one of the related resources, or the related features.

Step 3(b): Pivot on Feature

In some embodiments, it is contemplated that the feature can be used as a search term on the underlying data store, and the returned set of results and resources can be presented as a list. The user can then subsequently navigate to any of the matching resources as discussed herein.

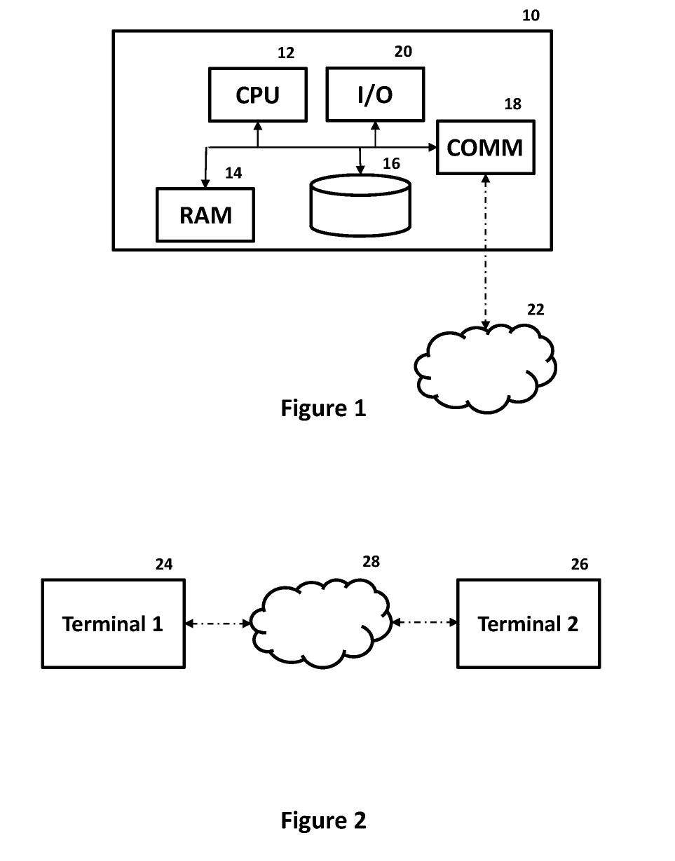

Turning to FIG. 1, at least one embodiment of a computer terminal 10 that can be used in connection with the present invention is illustrated. It will be readily appreciated that computer terminal 10 can take the form of a desktop computer, laptop computer, a mobile device and remote server, among any other suitable types of computer terminal that will be readily understood by the skilled person.

In this embodiment, computer terminal 10 includes a processor 12 (such as, but not limited to, a central procession unit, among other arrangements that will be readily appreciated by the skilled person) in electronic communication with temporary storage 14 (such as, but not limited to, static or dynamic random access memory, among other arrangements that will be readily appreciated by the skilled person), database storage 16, a communications module 18 and any suitable input/output peripheral 20. Communication module 18 can include, but is not limited to, a radio frequency module or an optical communication module as will be readily appreciated by the skilled person. Moreover, it is further contemplated that communications module 18 may include transmitting and receiving functions and may be in wired or wireless communication with optional remote database storage 22.

Turning to FIG. 2, an embodiment demonstrating two computer terminals, pursuant to FIG. 1, in communication with one another is illustrated. In this embodiment, first computer terminal 24 is in wireless, remote communication with second computer terminal 26 through a communication network 28, however other arrangements are also contemplated as will be readily understood by the skilled person. In this embodiment, it is contemplated that first computer terminal 24 and/or second computer terminal 26 can be a desktop computer, laptop computer, a mobile device and remote server, among any other suitable types of computer terminal that will be readily understood by the skilled person. In the present context, it is contemplated that the first and second computer terminals 24, 26 can function as distributed system node(s) as will be readily understood by the skilled person.

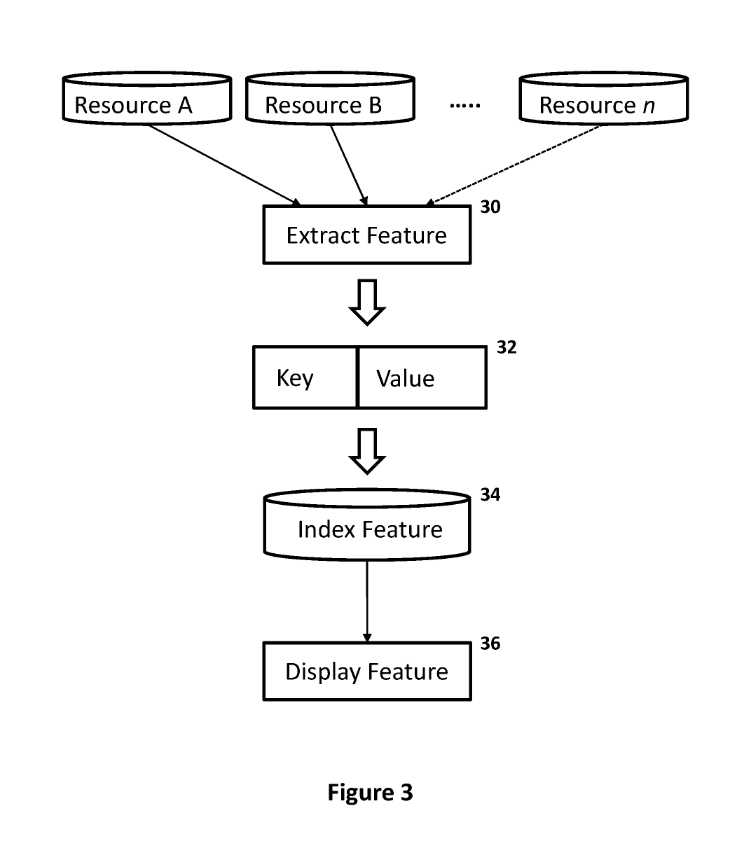

Turning to FIG. 3, at least one embodiment of the present invention is illustrated. In this embodiment, at least one feature is extracted from at least two resources that is located in at least one database 30. As will be understood by the skilled person, it is contemplated that the at least one database can be a local database or a remote cloud database, among any other database arrangement that will be readily appreciated by the skilled person.

Moreover and as discussed previously, resources that can also be understood to include text files and documents, image files and documents, music files, among any other type of digital files that will be readily appreciated by the skilled person. Further, it is contemplated that the presently considered features can include, but are not limited to, metainformation values, terms, sequences of terms, n-grams of terms, named entities, or any other machine-identifiable property that can be calculated within the context of a single document or digital resource, as will be readily understood by the skilled person.

Further, it is contemplated that extraction can be achieved using any suitable set of known file format text extraction utilities as will be readily understood by the skilled person.

It is contemplated that a suitable feature is next subsequently represented as a key value pair wherein the key represents the nature of the feature and the value represents a semantic value for that feature 32.

Next, the feature (i.e. key value pair) is indexed in a suitable data store 34, which can be analogous to the database where the resource was initially retrieved from or from a completely separate data store, such as but not limited to a local database or a remote cloud database, among any other database or data store arrangement that will be readily appreciated by the skilled person.

Finally, the feature can be displayed to a user through any suitable means 36. As will be understood by the skilled person, this can include a graphical, user interactive interface provided on a suitable computer terminal peripheral that allows a user to view and evaluate the displayed feature in order to determine a suitable train of inquiry.

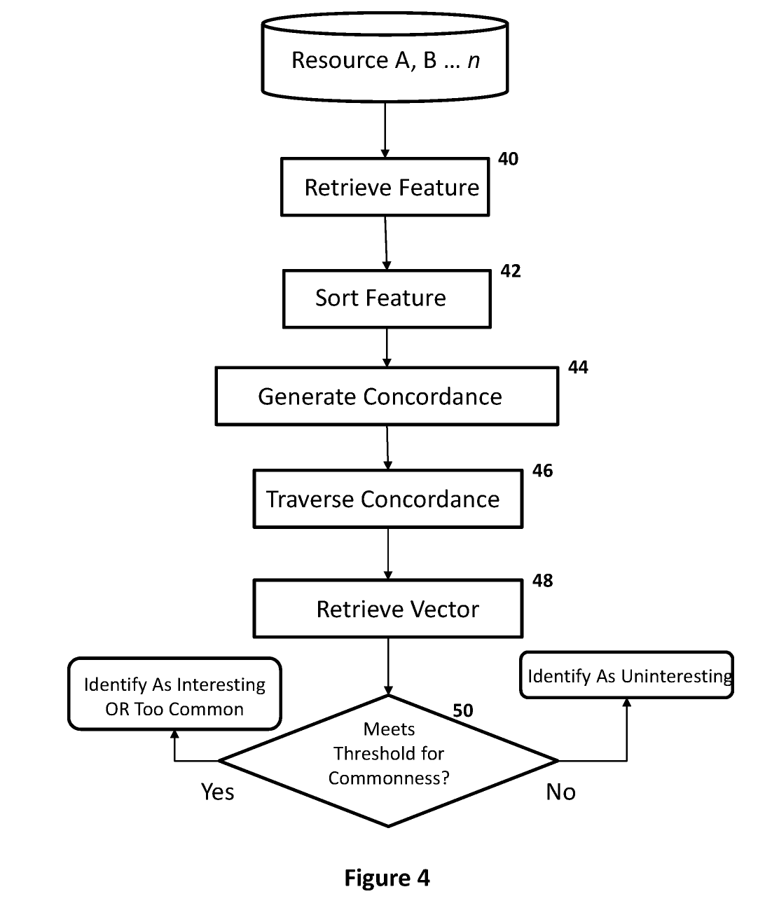

Turning to FIG. 4, another embodiment of the present invention is illustrated. In this embodiment, it is contemplated that the at least one feature associated with at least one of the plurality of resources under consideration is retrieved (i.e.: pushed or extracted) from a suitable data store or database 40 as also discussed previously at step 34.

Once this feature is retrieved, it can be sorted based on a predetermined quality factor 42 as previously discussed herein. Following this step, a concordance can be generated 44 that is related to the resource under consideration and which is based on the at least one feature that is sorted at step 42.

Subsequently, the generated concordance can be traversed 46 and a suitable vector can be retrieved 48 as previously discussed herein. Next, the retrieved vector can be checked against a predetermined threshold for commonness 50. If the retrieved vector meets the predetermined threshold for commonness, an interesting interrelation has been identified and the method need not proceed further. However, if on the other hand the retrieved vector does not meet the predetermined threshold for commonness, the vector may be discarded as not interesting and a subsequent vector can be retrieved at step 48 and in at least one embodiment the process can be repeated until the predetermined threshold for commonness is met and an interesting interrelation has been identified.

In other embodiments, it is contemplated that if the retrieved vector meets the predetermined threshold for commonness the method can continue to check the retrieved vector to identify the maximum number of features that exceed the predetermined threshold for commonness. In these embodiments, a feature that exceeds the predetermined threshold for commonness can be deemed not interesting as the feature is far too common to provide any substantive value to the inquiry, as discussed above and as will be readily understood by the skilled person.

The present disclosure provides for reference to specific examples. It will be understood that the examples are intended to describe embodiments of the invention and are not intended to limit the invention in any way. Moreover, it is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

What is claimed is:

1. A method for feature-selectivity investigative navigation of a plurality of resources, comprising the steps of:
extracting at least one feature from each of the plurality of resources, the at least one feature corresponding to each of the plurality of resources, the at least one feature represented as a key value pair including a key corresponding to the nature of the at least one feature and a value corresponding to the semantic value of the at least one feature;
indexing the at least one feature in a data store; and
displaying the relationship between each at least one feature and the plurality of resources.

2. The method of claim 1, further comprising the step of:
retrieving at least one feature associated with one of the plurality of resources;
sorting the at least one feature based on at least one predetermined quality factor;
generating a concordance related to the one of the plurality of resources based on the sorted at least one feature;
traversing the concordance in a predetermined order and retrieving a feature vector corresponding to each element in the concordance until the retrieved feature vector reaches a predetermined threshold for commonness.

3. The method of claim 2, wherein the feature is at least one n-gram calculated from at least one string of text extracted from at least one of the plurality of resources.

4. The method of claim 3, wherein the at least one n-gram is calculated by applying a rolling window to the text stream to generate at least one n-let, the rolling window having a fixed input size n;
lemmatizing the at least one n-let;
alphabetically sorting the at least one n-let to generate at least one n-gram;
hashing the at least one n-gram with a uniform hash function to generate at least one multi-byte token; and
storing the at least one multi-byte token in the data store and associating the at least one multi-byte token with the at least one of the plurality of resources.

5. A system for feature-selectivity investigative navigation of a plurality of resources, comprising:
a computer terminal comprising a processor, temporary storage, database storage, a communication module and at least one peripheral, the computer terminal adapted to:
Extract at least one feature, the at least one feature corresponding to at least one resource, the at least one resource stored in at least one of the temporary storage and the database storage, the at least one feature represented as a key value pair including a key corresponding to the nature of the at least one feature and a value corresponding to the semantic value of the at least one feature;
Indexing the at least one feature in a data store; and
Displaying the relationship between the at least one feature and the plurality of resources on the at least one peripheral.
